(19) United States
(12) Patent Application Publication
(10) Pub. No.: US 2006/0161564 A1
(43) Pub. Date: Jul. 20, 2006

(54) Method and system for locating information in the invisible or deep world wide web

(76) Inventors: Samuel Pierre, Laval (CA); Dougoukolo Konare, Laval (CA)

Correspondence Address: FAY KAPLUN & MARCIN, LLP, 15O BROADWAY, SUITE 702, NEW YORK, NY, 10038, US

(21) Appl. No.: 11/314,898

(22) Filed: Dec. 20, 2005

Related U.S. Application Data
(60) Provisional application No. 60/636,865, filed on Dec. 20, 2004.

(51) Int. Cl. G06F 17/00

(52) U.S. Cl. 707/100

(57) ABSTRACT

A system that allows location and extraction of information from database driven web sites that are part of the deep web is described herein. The system uses an automatic wrapper generation mechanism that understands the meaning of deep web pages, extend search technologies capabilities, and help users extract information from database driven web sites. A method therefor is also described herein.

### FIELD OF THE INVENTION

The present invention relates to locating and extracting information from the invisible or deep world wide web (the “web”) using wrapper generation, machine-learning, and deep web knowledge.

### BACKGROUND OF THE INVENTION

With the huge quantity of information that is continuously growing, the web represents the most used source of information in the world. It has originated in the universities and research labs; today its use has grown considerably: from mostly private use at the beginning, the web and the Internet are now widely used by businesses and public agencies alike and the quantity of information found on the web grows on a daily basis. The usefulness of the web is proportionate to the ease of locating and extracting the information sought. Given the continued expected growth of the web, if better tools and protocols to ease the manipulation of the web are not developed, the web will become for the most part uncontrollable, unusable and inefficient.

Web Search Technologies

The web is composed of many various types of documents representing text, video, sound, and images for instance. Such documents are commonly known as “web pages”. Web pages are linked to each other by hyperlinks: a click on a hyperlink permits to access another web page, thereby “surfing the web”. Some web pages are indexed by search engines, they represent the “visible web”. However other parts are not so indexed, although generally accessible, and they are known as the “invisible web”, “deep web”, or “hidden web” [hereinafter, referred to as the “deep web”].

Typically a web page follows the HTML syntax defined by the W3C. More specifically, a web page contains a header and a body. The header consists of information on the page per se such as the title and general information on the contents. In certain pages, the header consists of “meta information”, which is information on the web page such as its title, description, keywords, refresh rate and how often it should be accessed by search engine for indexation; such information is typically used by search engines to index the various pages. The information on such pages, even if frequently updated or modified is generally “static” since the information found on a page is universal, it does not vary from one user to another according to their specific requests or queries. Such web pages can easily be created by anyone or by an automated process.

On the other hand however, some pages are designed using server side scripts that generate dynamic content, and such sites are known as database driven web sites. Generated to a user's specific request or queries, such pages are like templates that are processed by a script engine or by any process written in any language that can input and output HTTP requests, and are created only upon the user's request. Depending on the technology, the pages can be stored for a short time on the server or not.

The “visible web” therefore consists of all multimedia documents or web pages that are indexed by search technologies while the deep web represents all multimedia documents or web pages that are not indexed by those search technologies.

The deep web is composed of “dynamic” content and semi-structured text for the most part. Most of the web pages forming the deep web are generated from database query and there are many reasons why they are not indexed by search engines.

Search technologies known as “crawlers” have limitations due to the fact that there is a cost associated with indexing a site. Some search technologies simply cannot index the whole hierarchy of a web site so they reference only a few pages or parts thereof. Furthermore, they sometimes deliberately omit to reference certain types of multimedia documents for lack of descriptive content.

Database driven web sites represent dynamic sites and are estimated to represent the larger part of the deep web. Some of their pages obtain their content from associated databases. For example, a query that extracts 800 records from databases and outputs them to multiple pages with 10 records per page would create 80 different pages. Given the limitation of crawlers, those pages will, in all likelihood, not all be indexed. Moreover, since some of those pages are simply not hyperlinked (they are created on demand), they will not be accessed by the crawlers. Finally, as the content of database driven web sites changes frequently, they are not able to be queried by current search engines.

Search technologies are evaluated using many criteria including quantity, quality, speed, and the user interface (i.e., how easily the query is entered or defined). Search technologies can generally be categorised into four different groups: search engines per se, directories, meta search engines, and specialized search engines. These technologies are believed to be well known to those of ordinary skill in the art and, accordingly, will not be further described in the present specification.

Another problem with current search engines is that the web has no content description, no ontology, and words can have different meanings depending on context. Since current global search engines do not understand the context, they blindly collect as much information as they can with no reference to the actual meaning of the content of the web pages.

Information Location and Extraction Technology and Wrapper Generation

Generally speaking, information location and extraction is originally the task of locating specific information from a natural language document, and is a particularly useful area of natural language processing. Those documents are unstructured text (a.k.a. “free text”), semi-structured text or structured text. Semi-structured text is between free text and structured text. Database driven web sites part of the deep web are generally formed of semi-structured text.

While information location and retrieval is based on selecting a subset of documents from a larger collection on the basis of a user query, information location and extraction emerged from rule-based systems in computational linguistics and natural language processing. IE (Information Extraction) systems are designed with the knowledge engineering approach or the automatic training approach.

In the knowledge engineering approach, the rules are defined by a knowledge engineer, i.e., someone who is familiar with the domain where the IE system will be applied. Those rules define the nature of the information to extract. The knowledge engineer works with a subset of all possible texts. The performance of a system is defined by how well the rules are defined by the knowledge engineer. The approach is iterative and time consuming because it is done by a human; it requires a fairly arduous test-and-debug cycle, and is dependent on having linguistic resources at hand, such as appropriate lexicons, as well as someone with the time, inclination, and ability to define the rules. If any of these factors are missing, then the knowledge engineering approach becomes problematic.

In the automatic training approach, there is no direct human intervention required to define the rules. Human intervention can be useful nonetheless to annotate the texts. In order to retrieve the texts, the system is trained first on a corpus that has been annotated. That kind of approach is domain portable but requires training data.

An IE system is essentially composed of a tokenizer, a morphological processor, a lexical processor, a syntactic analyzer and a domain analyzer.

The tokenizer assists in delimiting words, sentences, and predicates. Depending on the language spaces, punctuation signs may help in the tokenization process. For some other languages, such as, for example, Chinese and Arabic, it is more complicated as a spoken word does not necessarily correspond to a written word.

A morphological processor helps in finding the variant of a word. Depending on the language, that component could be small or big. For example French words have more variants and synonyms than English words.

The lexical processor helps in finding general domain languages in the text. The lexical processor can be compared to a knowledge base where meaning is to be found for a text to be parsed. The lexical processor tries by using different technique to understand dates in the texts, names and/or other features. That is useful to understand the meaning of the text (events, location, object, etc.).

Syntactic analysis involves parsing the text and getting the structure of phrases. During the parsing, a semantic analysis tries to apply first order logic in order to extract predicates, proposition to part of the text. Full parsing is not necessarily the right solution because it is time consuming.

The domain analyzer uses co-referencing and merging in order to determine relations between words, sentences, events. It is a very complex task that gives good results with domain specific information.

Wrapper Generation

Wrappers are tools dedicated to the extraction of information from one or many sources. They are built manually, using the knowledge engineering approach, or automatically, using the automatic training approach. In the web environment, the purpose of wrappers should generally be to convert information implicitly stored as an HTML document into information explicitly stored as a data structure for further processing. To extract information from several sources, a library of wrappers is needed. Ideally, the wrapper should also be able to cope with the changing and unstable nature of the web, like network failures, ill-formed documents, change in the layouts, etc.

Tools for helping the manual construction of wrappers already exist. They generally use a graphical user interface. Automatic wrapper generation uses induction and machine learning techniques known to those of ordinary skill in the art. Some of them use some human intervention but they are nevertheless automatic. That kind of approach uses a learning approach with an induction mechanism for constructing the wrapper. Two approaches exist: the bottom-up and the top-down approaches.

The bottom up approach is data driven, and starts with selecting one or more examples and formulates a hypothesis to cover those examples and then generalises the hypothesis to cover the rest of the examples.

The top-down approach starts with the most general hypothesis available, making it more specific through the introduction of negative examples. Inductive learning is the task of computing from a set of examples of some unknown target concept, a generalisation that explains the observations. The idea is that a generalisation is good if it explains the observed examples and makes accurate predictions when previously unseen examples are encountered. Inductive learning is accomplished through inductive inference, the process of reasoning from a part to a whole from particular instances to generalization, or from individual to universal.

Wrapper generation plays a key role in the knowledge engineering process. Wrappers are used by recent data integration system in order to talk to remote sources using query languages like webSQL, for example. The main difficulty in building wrappers in a web environment is that the HTML web page is usually designed for human viewing, rather than for programmatic manipulation of data by programmes.

Commonly used web search engines do not use sophisticated information location and extraction technology or wrapper generation to locate web pages pursuant to a user's query. Typically, simple keyword matching algorithms are used.

There is therefore a need to develop new search technologies that search deeper into the web in order to locate as much information as possible and to use intelligent searching, such as common ontologies or semantic annotations, in order to use the meaning of a page as opposed to mere keyword matching to provide better and more relevant search results.

### OBJECTS OF THE INVENTION

It is therefore an object of the present invention to provide an improved method and system to extract information from sources that are not accessible or too costly using current search technologies and current answering systems.

### SUMMARY OF THE INVENTION

More specifically, in accordance with the present invention, there is provided a search method for locating and extracting information from databases accessible through dynamic web pages including delimiters, structure elements, information and a navigation organization, the method comprising the steps of: reproducing information contained in one of the dynamic web pages inside a vector; separating the delimiters from the information in the reproduced information; generating at least one wrapper based on the vector and defining a data structure containing the information and the structure elements of a dynamic web page; determining the navigation organization between the dynamic web pages; and using the determined navigation organization, extracting information corresponding to the information contained in the at least one wrapper.

The present invention also relates to an information locator system for locating and extracting information from databases accessible through dynamic web pages including delimiters, structure elements, information and a navigation organization, the information locator system comprising: a parsing tool so configured as to reproduce information contained in one of the dynamic web pages inside a vector with the delimiters being separated from the information; a wrapper generation tool so configured as to generate at least one wrapper defining a data structure containing the information and the structure elements of a dynamic web page; a navigation system finder so configured as to determine the navigation organization between the dynamic web pages; and an information extraction tool using the determined navigation organization and so configured as to extract information corresponding to the information contained in the at least one wrapper.

The foregoing and other objects, advantages and features of the present invention will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is an example of a web page found in the deep web, this web page being a French-language web page to show that the method and system according to the present invention are not restricted to a particular language;

FIG. 2 is a chart providing basic elements of an embodiment of the present invention;

FIG. 3 is a flow chart providing steps used by an embodiment of the present invention;

FIG. 4 is a flow chart providing steps of a parsing tool of an embodiment of the present invention and a table or library of parsed Nodes and StringNodes;

FIG. 5 is a flow chart providing an activity diagram of an automatic wrapper generation process;

FIG. 6 is a table presenting an example of a heuristic to generate the wrappers;

FIG. 7 is a flow chart providing steps of a navigation system generation tool according to an embodiment of the present invention;

FIG. 8 illustrates two generated wrappers from an extraction process; and

FIG. 9 illustrates a data structure where the data is not presented on the same page.

### DETAILED DESCRIPTION OF THE ILLUSTRATIVE EMBODIMENTS

Generally stated, an illustrative embodiment of the present invention is concerned with a system that allows extraction of information from database driven web sites that are part of the deep web. The system uses an automatic wrapper generation mechanism that understands the meaning of deep web pages, extend search technologies capabilities, and help users extract information from database driven web sites. A method therefor is also described herein.

Example of Deep Web Searching

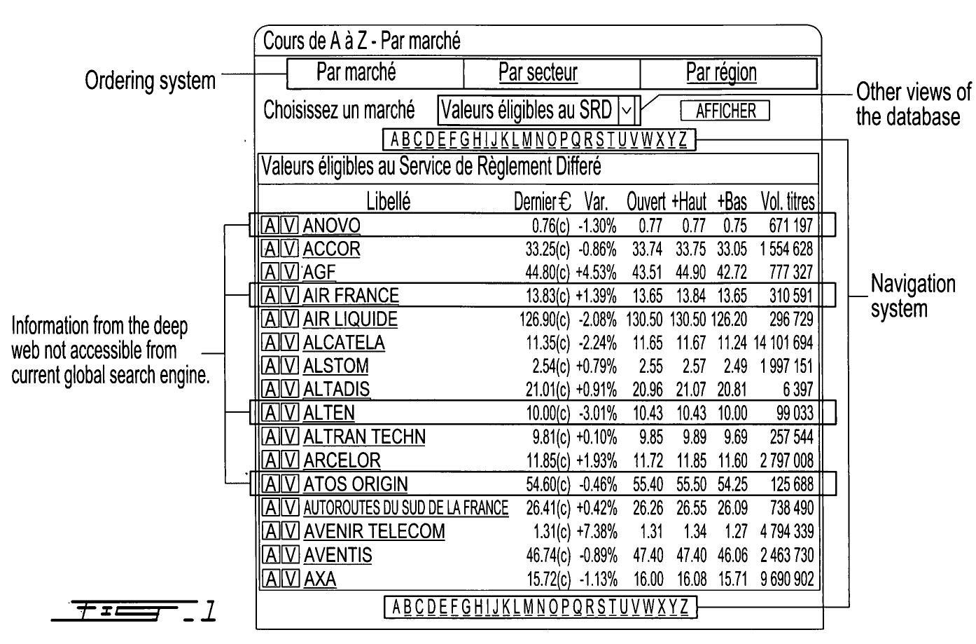

FIG. 1 shows an example of database derived web page that can be found in the deep web. Encyclopaedias, libraries, yellow pages, online stores are among the type of web sites connected to databases. Their pages are essentially composed of two parts: presentation and navigation. The information presentation section contains information extracted from one or many databases.

That information is directly extracted from databases and formatted following defined presentation logic. Global search engines do not have access neither to the databases nor to the information. The information is accessible through local search engines or via predefined queries, disseminated in the site. They represent different view of the database pursuant to a user's need.

The navigation system shown at the bottom of the page shown in FIG. 1 allows a user to move inside the extracted information. Without the navigation system, all the information is shown on one page. That style of presentation is not user oriented because presenting a list of hundreds of records on a single page is tedious for reading and finding the right information uses more bandwidth; however it is good for rapid processing.

Present HTML pages use many techniques to present data and information. Table 1 summarises a list of presentation styles showing how semi-structured information can be presented.

TABLE 1
Tables, lists and tags

| | | |
|---|---|---|
| <table> | <ul> | Info1<br> |

| | | |
|---|---|---|
| <tr><td>info1</td></tr> | <li>info1</li> | Info2<br> |
| <tr><td>info2</td></tr> | <li>info2</li> | Info3<br> |
| <tr><td>info3</td></tr> | <li>info3</li> | Info4<br> |
| <tr><td>info4</td></tr> | <li>info4</li> | ... |
| ... | ... | |

| | |
|---|---|
| </table> | </ul> |

One can see that semi-structured information is presented between delimiters. HTML delimiters like tables, tags, or lists tags are among those delimiters. The difficulty in building a tool that can search in many databases driven sites from the deep web comes from the fact that there are no common structures between all those sites, even between different pages of the same site, and some pages can have errors that can affect a search.

With hundreds and even thousands of records to print to the screen, the presentation logic can sometimes be very complex. The presentation logic corresponds to the MVC (Model View Controller) pattern; it defines the different ways information should output to the user interface. Each different way of presenting an amount of information coming from a data source represents a state. For example if there is an alternation of colours between the presentation of various records, the presentation logic for that particular information is said to have two states. In programming, those states are conditions (e.g., if . . . then . . . else, switch . . . case, etc.).

Therefore, to improve search methods and particularly to allow searches of the deep web, it would be required to generate a wrapper that can build itself based on what it learns on each site, which is presently absent in current web search technologies. That wrapper of course would need to understand the ontology of web extraction which is based on human experience.

At the outset, the ontology of the information locator according to an embodiment of the present invention from the characteristics of deep web pages as discussed hereinabove has to be defined.

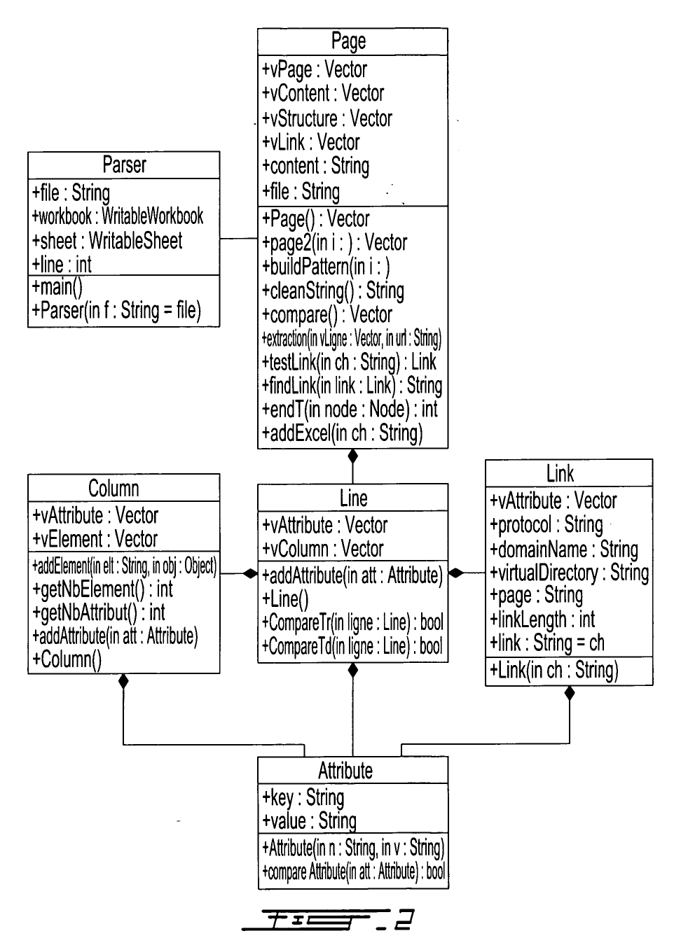

The elements presented in FIG. 2 are basic elements in order for the information locator to understand the deep web information structures: page, line, column, hyperlink, and attribute. From the perspective of the information locator, a web page contains a set of repeating structures related to data sources and those repeating structures can be identified. There is no representation of all other information outside those structures. Such other information is static, it is not related to databases and it does not vary from page to page.

A line structure represents an instantiation of the repeating structure. It could be a line of information, it could be presented by a table row, a list or other delimiters.

A column structure represents information separated by delimiters.

An attribute structure represents the attribute of pages, lines, columns and links. The attribute structure is a pair of key value, it represents a HTML attribute.

There are also elements that represent each individual tag, delimiter or information inside a cell. In fact, an element is everything that is between a HTML tag. A cell can contain many things such as hyperlinks, images, other tags, information, and even a nested structure of tables. Each individual tag for a table represents an element. They are stored inside a vector. With the ability of the column structure to contain an element as an object, it can receive an attribute or other objects like lines of a nested table. So the classes that have been defined allow the information locator to save the complete structure of a page. In other words, the information locator has the knowledge of the structure of any page coming from the deep web.

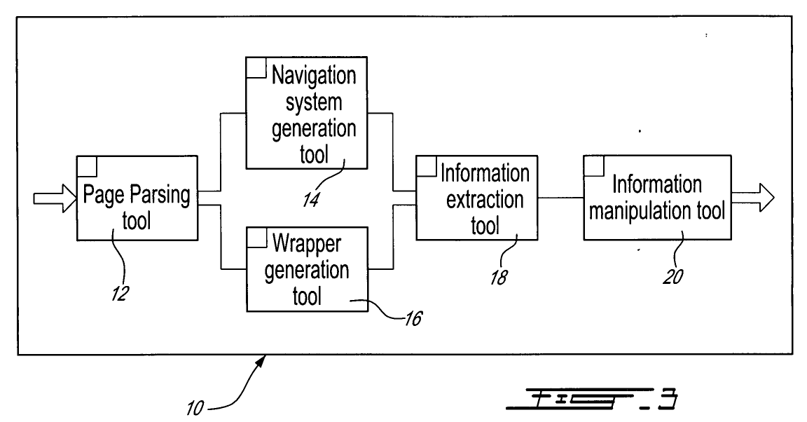

FIG. 3 shows the five main components of an information locator 10 according to an illustrative embodiment of the present invention. The first component is the page parsing tool 12. After the information locator has parsed the page, the navigation system generation tool 14 and the wrapper generation tool 16 process in parallel. The structure of the site is memorised and the information locator 10 extracts all information from all the pages using the information extraction tool 18 and the information manipulation tool 20 is finally called.

The information locator 10 may be used in conjunction with a regular search engine. Indeed, once the results are returned from the indexes of the search engine, the information locator 10 searches all the returned web pages that get their information from databases. In an alternate embodiment, the user obtains a database driven web page where there is a repeating structure and decides to extract all information from it for further processing.

Page Parsing

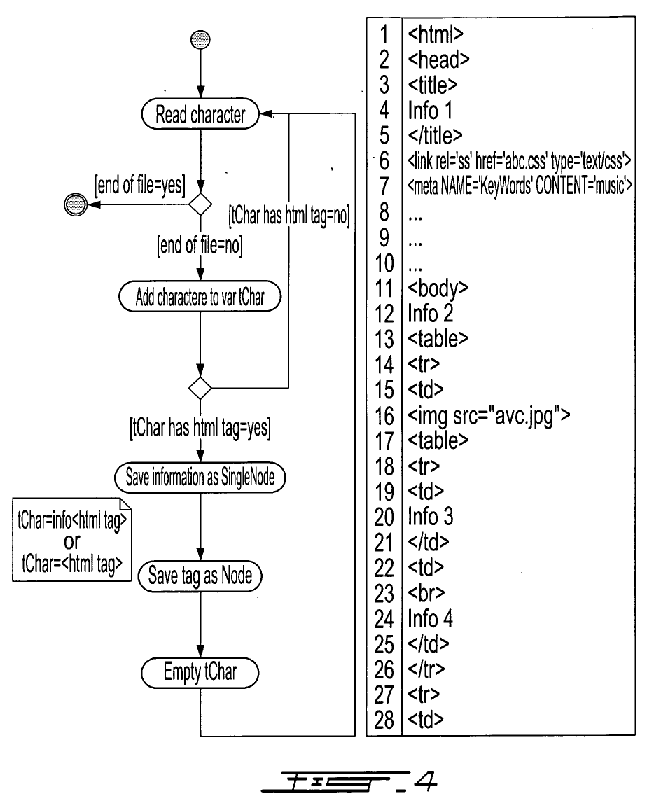

The general object of the page parsing tool 12 is to obtain a dynamic web page and then process its content. A web page designed such that it has its DOM (Document Object Model) accessible is more time efficient. FIG. 4 illustrates a method for dynamic page processing that may be performed by the page parsing tool 12. Once the page is downloaded via the “get” method of the HTML protocol, it is parsed as Nodes (HTML tags) and StringNodes (non-HTML tags, i.e., information poor or good). Therefore, everything that is not a tag is qualified as information and elements (Nodes and StringNodes) are read and placed sequentially in a growing table or library as shown in FIG. 4. It is also possible to use a predefined parser such as HTMLParser, an open source java library under the GNU license available at SourceForge.net. Nodes are HTML tags and StringNodes are text, characters other than HTML tags. Because of the presence of an iterator, it is possible move easily inside the parsed page.

The object of the page parsing tool 12 is to reproduce the structure of an HTML page inside a single table or vector called vPage that will facilitate the wrapper generation and the extraction of information as will be described hereinbelow. The page parsing tool 12 separates information from tags, it does not find patterns per se.

For example, Table 2 hereunder represents the sequence of operations when the parser is given the following code: info<br><table>:

TABLE 2

| | | | |
|---|---|---|---|
| I | Info< | Separate tag from information | <ta |
| In | Info<b | Empty tvar | <tab |
| Inf | Info<br | < | <tabl |
| Info | Info<br> | <t | ... |

Wrapper Generation Tool

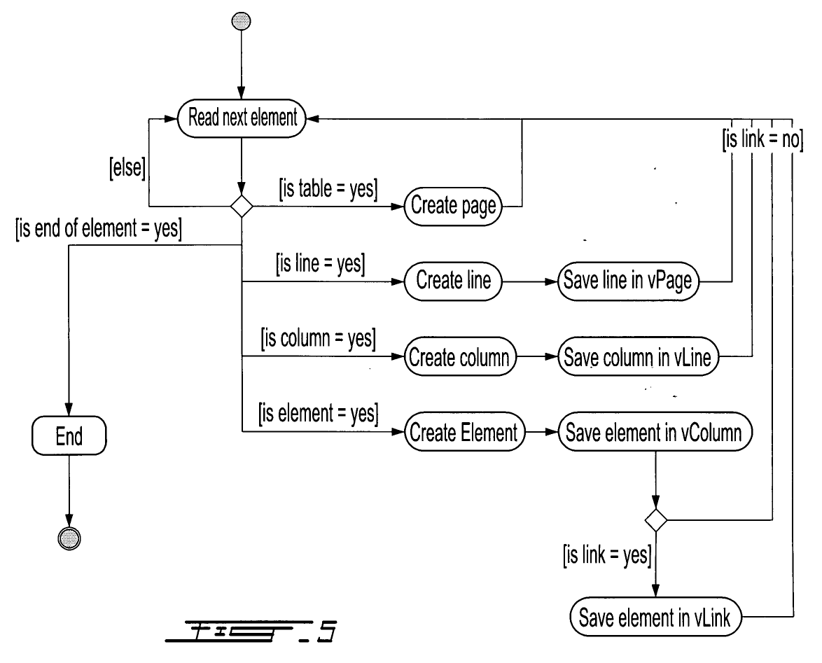

The wrapper generation tool 16 is an automatic wrapper generation element. Based on similarity between lines of information on a web page, the wrapper generation tool 16 constructs a wrapper for a particular set of records. Firstly, given the ontology defined in FIG. 1 and the output from the page parsing tool 12, the information locator 10 restructures the page in its knowledge base. FIG. 5 shows the activity diagram of the automatic wrapper generation process.

The purpose of the wrapper generation tool is to present tags and information in a structure of classes and sub-classes. That process aims at creating a DOM version for the page to ease its manipulation at a later step. There is a possibility of generating a wrapper based only on the output of the page parsing tool 12 but that would fail to take advantage of DOM features and HTML tags that are delimiters. Indeed, HTML lines and column tags are very good delimiters of information that help structuring the web page. If they are not used, the right delimiters need to be found using pattern discovery heuristics. Such method generally requires more time.

The automatic wrapper generation process done by the wrapper generation tool 16 starts as follows (see FIG. 5). The first line of vPage is read. If it is a structure, then a structure is created. Then the next element of vPage is read and the process is looking for a line then a column. A pattern is a set of repetitive tags and information that have, from the human perspective, approximately the same visual output. As mentioned above, deep web pages present parts of its content following a presentation logic that uses tables, lists or others. Therefore, in some particular cases, a structure represents lines of a table, they are defined as “tr” tags or they represent elements of a list defined as “li” tags. The use of other types of delimiters could easily be envisaged.

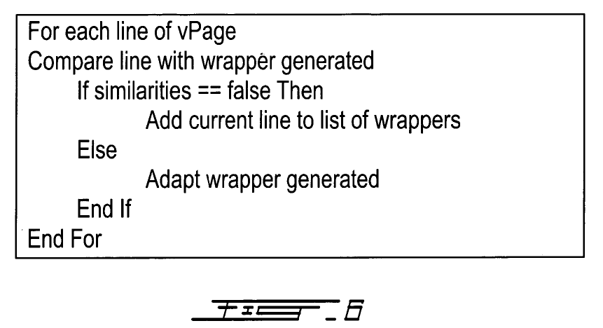

In this embodiment, the information locator 10 uses a bottom-up approach in order to generate or build the wrappers. It selects the first line of vPage and makes a general hypothesis by assuming that all other lines look like this first line. The first line of the vPage is considered as a generic wrapper with mandatory columns and mandatory attributes. Then, the second line of vPage is read and a comparison algorithm is applied with the first wrapper generated. Depending on the results of similarities applied with the wrapper generated, a second wrapper is generated or the first one is changed to have optional or confirm the mandatory attributes. Then the third line is read and compared to the list of previously generated wrappers. Depending once again on the similarities results, a new wrapper is generated or the previously created one is adapted. The heuristic to generate the wrappers is quite simple and an example of which is presented in FIG. 6. Essentially, the heuristic to generate the wrappers is based on the premise that there exists some similarities and little differences between the different lines of a dynamic web page.

The similarities method is based on a statistical method. They are founded on many premises that are based upon actual user experience and they define the robustness of the heuristic. If the similarities method that is applied is too strong, every line will become a wrapper. On the other hand if the similarities method is too weak, every line will be represented by one and only one wrapper.

The information locator 10 according to an illustrative embodiment therefore applies one ground rule: two similar lines have the same number of columns and their columns have the same width. Other more specific rules are defined during the wrapper generation process. For example, attribute orders are such as their value are often interesting. Inside a column the number of elements with their order and values are often interesting. Semantic analysis could be done on the content of information.

Therefore, for each comparison, a similarities matrix is built and the heuristic is used in order to generate a new wrapper or to modify one that has previously been created. In order to adapt the wrapper, it is possible only to leave the mandatory tags and attributes. All other tags that are optional may not be part of the wrapper.

In order to generate the best wrappers, the wrapper lists can be cleaned by deleting for instance those that have only one line of similarities since they have been created only because there was only one type of that line in the entire page.

Navigation System Generation Tool

In order for the information locator 10 to extract all the information from the different pages, it has to understand and follow or navigate the right links. During the wrapper generation process, all links of the root node page are placed in the queue for later processing by the navigation system finder. In this step, the information locator 10 tries to move from the root node to other nodes and the right search algorithm needs to be applied. Many known search algorithms exist. Prior art search engines basically use one of the two following techniques: Depth-first search and Breadth-first search.

Considering the web as a tree with any starting point as a root node with siblings and children nodes, the depth first explores the children of the first node until a goal is reached while the breadth-first will explore all siblings of the root node before children are expanded and explored. In the navigation system finder used in the present invention, with a node representing a hyperlink, a one level breadth-first search algorithm is applied. The general purpose is to select all nodes that have some similarities with the root node. As many nodes can fill the appropriate criteria, a hyperlink exploration is required in order to compare the children pages with the root page. An example of an algorithm that can be used is presented in Table 3.

TABLE 3
Level 1 breadth-first algorithm

For each link in vLink

If link is similar with current link page
with one character difference Then

Visit that link
If page visited has the same structure as 1st
page Then

Save link as next or previous page link

End If

End If

End For

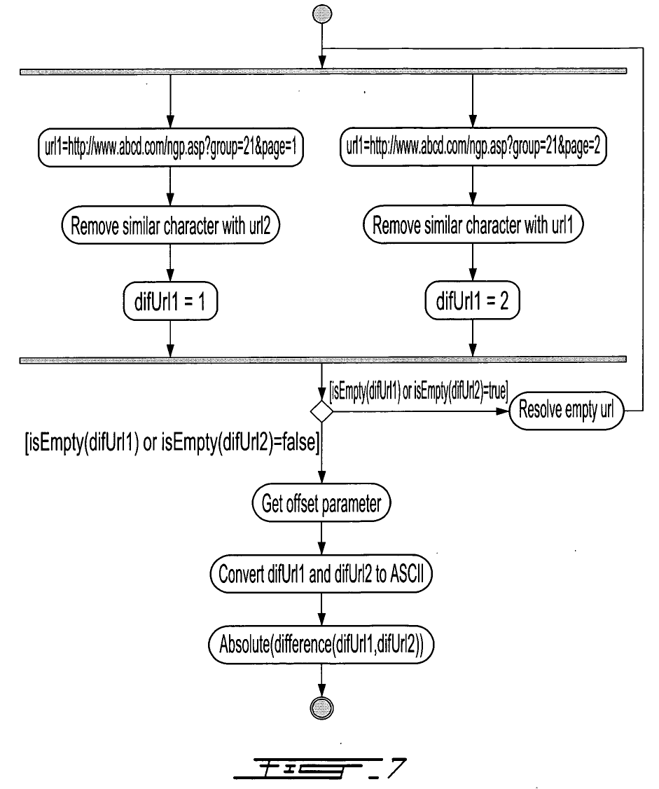

Once the children pages have been identified as next or previous pages, the information locator can start building the navigation system. Knowing that two consecutive pages have the same hyperlink with only one parameter value difference, that parameter defines the offset of the position of the information in the pages. In this next step, the object is to discover the pattern of the navigation system. The activity diagram presented in FIG. 7 explains the appropriate heuristic. Such heuristic helps to identify the offset parameter in its current value and in the next or previous values. Once those values are known, the information locator 10 is able to move backward and forward, without conducting a general search each time. In some cases, the offset parameter and value in the root node can be identified, but they appear in next pages, as shown in the next example:
?p1=v1&p2=v2& . . . & pn=vn

The heuristic tries to resolve those cases one by one, knowing that one of those parameters represent the offset and its value. The information locator 10 tries the link exploration one by one by incrementing each value and exploring the corresponding link. Value parameters that have no sequence meaning or that have spaces, special escape characters or empty values are discarded.

When that heuristic does not guarantee the identification of the next or previous nodes, the information locator 10 conducts a full search and exploration of the root node links. Each time, the information locator 10 moves to the next node and conducts the same operation anew.

Generally a full search will occur when a navigation system exists but is not directly accessible. That is the case for frames, forms or embedded clients scripts. In such cases (i.e., where the POST method or cookies are used), breadth-first search of several levels is adequate.

The information locator 10 may also process forms or javascript links. Once the pattern of a page moving is discovered, each different page is requested from the first until the page returns no more information.

Information Extraction Tool

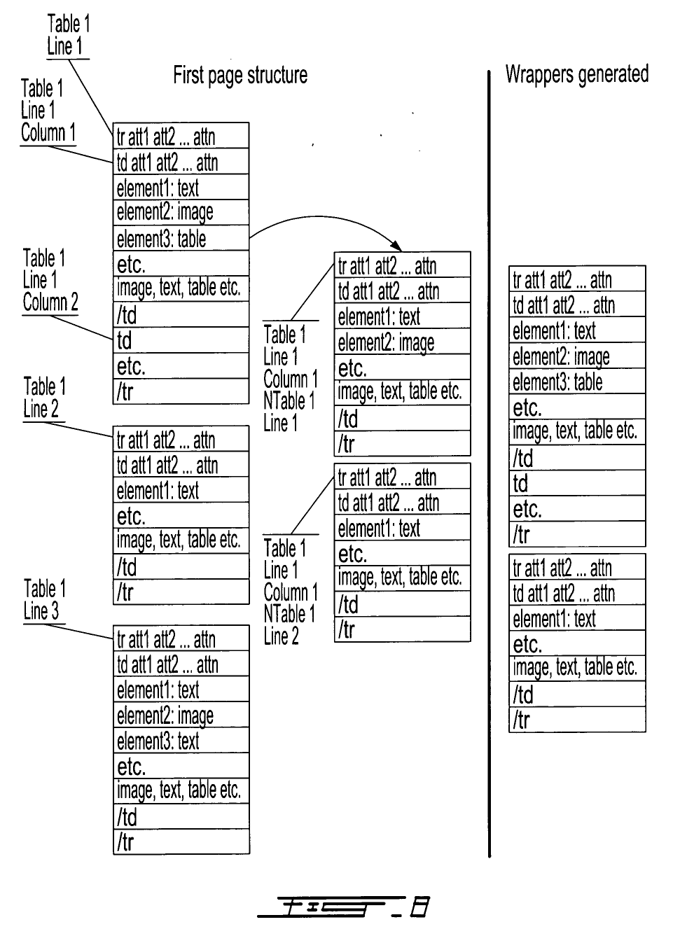

Once the wrappers have been generated by the wrapper generation tool 16, and the navigation system finder has been resolved by the navigation system generation tool 14, the information extraction tool 18 comes into play. FIG. 8 provides an example of the process to be used.

This process involves parsing the whole deep web site database and finding structures similar to the generated wrappers by the wrapper generation tool. Pattern matching with the wrappers is advantageous.

More particularly, FIG. 8 represents two generated wrappers with mandatory fields. The order in which the wrappers are found is important. In fact, the wrappers could form only one wrapper because they represent two or more consecutive lines that appear in a sequential order. Some web sites use lines of colours as separators between lines of information. The extraction information tool 18 of the information locator could therefore query the user as to which wrapper he prefers. The extraction information tool 18 works as follows: when the information locator 10 comes to a new page through the navigation system, it extracts only those lines of information that correspond to the mandatory fields of the wrappers. Optional fields by the name are optional: information could be present or not, it does not depend upon the optional settings. The information extracted is then sent to the information manipulation tool 20.

Sometimes sites are not well designed, errors are found inside HMTL tags, such as bad closing tags or missing tags. Depending on the browser, the user is usually able to see the page. Generally, errors found in tags presentation of web pages do not have much impact on the process of finding the information. Whether there are some errors or not in the tags, the information is located inside the page, inside the HMTL tags. The errors that are found on each line are also found by the resulting wrappers, so that when the information extraction tool 18 parses the information it expects to find those tag errors. The resulting information will be extracted between the HMTL tags (with or without tag error). Therefore the information locator tool 10 can still work correctly with poorly structured web sites.

Information Manipulation Tool

The information manipulation tool 20 represents a new presentation logic with tools that can process the content of useful information. It represents an interface with the user. The information is presented to the user in the way that the site developer wants to. Sometimes it is impossible to reorder, to cut, to move, to query this information. It is very time consuming to do these tasks manually. Because the user is the only one who knows exactly what the search is about, search engines help find pages, web sites, not information. So it is interesting to give the user the appropriate tool in order for him to find the relevant information. As a non-limitative example, Jexcel, a java library under the GNU or GPL license (for example JExcelApi is issued under the GNU Lesser General Public License), can be integrated and used as an information manipulation tool. That library allows the creation of style sheets and then puts the information from an entire data source and further allows easy manipulation, like sorting, selecting, sending to, or integrating it to another application. With that kind of tool, the user is able to interact and question the data, which is impossible to do with current search technologies. That tool is an example amongst those that can be used as an information manipulation tool; therefore other information manipulation tools could be used.

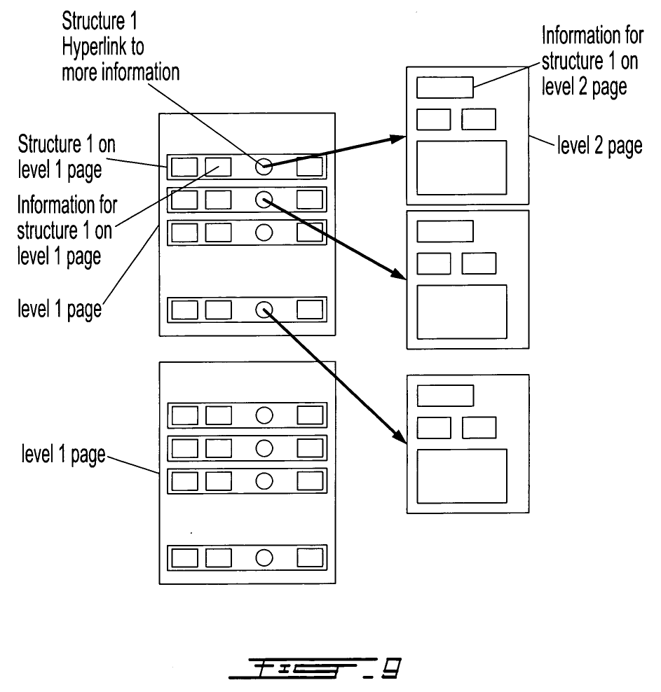

There are some cases where all the information of one structure is not presented on the same page. FIG. 9 illustrates such a case. In FIG. 9, it is illustrated that information found on the web can be disseminated on many levels; for instance, the information is separated by one hyperlink. In such cases, the information locator 10 can find the second and n-th level of disseminated information. Basically, the algorithm used is the same, but instead of comparing structures on the same page and getting the right wrapper, the algorithm compares next level pages and finds the correct wrapper to search and extract information. Some problems can occur. The next level link information can be password protected. In that way, it is not meant to be seen on the web. If using the information locator 10 concurrently with a search engine only, the search will not go further. However, if the information locator is used at least in part by a human user, then the user has the opportunity to enter his password on the site or in parts of the sites in order to make the search in the deep web.

Another problem is to know how far the exploration of the next level pages to obtain more information on the current structure is to proceed. If the system is meant to be used by a search engine only, the appropriate criteria can be set. If it is used at least in part by a human user, the user can decide during the page level exploration how far or deep he wants to go. Nevertheless, the information locator is able to find cyclic linking. Cyclic linking means that the children level pages have links that point to parents. By performing cyclic linking, the system finds out automatically the number of levels needed to get all the information of one structure. The next level page exploration could also stop whenever no wrapper is able to be created at that level.

Multithreading can be used in the process of implementing the present invention in order to accelerate the process.

The information locator 10 can also store the required information in order to perform a particular search in the deep site. Indexation of deep web pages is possible on a large scale. The required information could be stored locally on the user's computer using many techniques such as cookies, systems' registry, local databases. For indexation on large scale, a server is needed and clients make request to that server in order to get information from deep web pages.

The information locator 10 searches in web sites or parts of web sites. For the purpose of the information locator, a “web site” is defined by a starting hyperlink. That starting hyperlink could be the root of the site (the first page) or a page of the deep web.

When a site is too complicated for automatic processing, users can define the start and end of information, structures, next and previous links in order to help the algorithm in its finding process.

The invention can be language independent. Information could be written in English, French or Arabic or any other language. Information in order to be presented to the user has to be delimited.

The information locator is designed for use with any kind of database, from flat files to relational and all the others type of databases.

Although the present invention has been described hereinabove by way of illustrative embodiments thereof, these embodiments can be modified at will within the scope of the appended claims without departing from the spirit and nature of the subject invention.

What is claimed is:

1. An information locator system for locating and extracting information from databases accessible through dynamic web pages including delimiters, structure elements, information and a navigation organization, the information locator system comprising:
a parsing tool so configured as to reproduce information contained in one of the dynamic web pages inside a vector with the delimiters being separated from the information;
a wrapper generation tool so configured as to generate at least one wrapper defining a data structure containing the information and the structure elements of a dynamic web page;
a navigation system finder so configured as to determine the navigation organization between the dynamic web pages; and
an information extraction tool using the determined navigation organization and so configured as to extract information corresponding to the information contained in said at least one wrapper.

2. A system as defined in claim 1, further comprising an information manipulation tool so configured as to further process the extracted information.

3. A system as defined in claim 1, wherein the wrapper generation tool is so configured as to organize the information and the structure elements into classes and sub-classes.

4. A system as defined in claim 1, wherein the system is used in conjunction with a search engine so configured as to return dynamic web pages containing database information.

5. A system as defined in claim 1, wherein the parsing tool reads each dynamic page element so as to separate delimiters from non-delimiters and to place them sequentially in a vector as Nodes and StringNodes, respectively.

6. A system as defined in claim 5, wherein the parsing tool is given by HTMLParser.

7. A system as defined in claim 1, wherein the wrapper generation tool applies a similarity algorithm against table elements generated by the parsing tool to create at least one wrapper.

8. A system as defined in claim 7, wherein the wrapper generation tool is an automatic wrapper generation element.

9. A system as defined in claim 8, wherein the automatic wrapper generation element creates a DOM version of the dynamic web page.

10. A system as defined in claim 9, wherein the basic structure elements represented in a wrapper are selected from the group consisting of line, column, attribute, page and hyperlink.

11. A system as defined in claim 1, wherein the navigation system finder applies a breadth-first algorithm search on the hyperlink elements found in the at least one wrapper, the hyperlinks being organized in a tree form.

12. A system as defined in claim 1, wherein the information extraction tool applies a pattern matching method to extract information from the dynamic web pages.

13. A system as defined in claim 12, wherein the pattern matching method allows the information extraction tool to extract only information corresponding to the information contained in the at least one wrapper.

14. A system as defined in claim 2, wherein the information manipulation tool represents a presentation logic with tools for further processing of the extracted information.

15. A system as defined in claim 2, wherein further processing of the extracted information is selected from a group consisting of sorting, selecting and integrating the extracted information into other applications.

16. A system as defined in claim 1, wherein the system is robust against poorly structured web pages since information are located inside delimiters.

17. A system as defined in claim 1, wherein second and n-th level of disseminated information can be found when information is presented on several pages of the dynamic web pages.

18. A search method for locating and extracting information from databases accessible through dynamic web pages including delimiters, structure elements, information and a navigation organization, the method comprising:
reproducing information contained in one of the dynamic web pages inside a vector;
separating the delimiters from the information in the reproduced information;
generating at least one wrapper based on the vector and defining a data structure containing the information and the structure elements of a dynamic web page;
determining the navigation organization between the dynamic web pages; and
using the determined navigation organization, extracting information corresponding to the information contained in said at least one wrapper.

19. A search method as defined in claim 18, further comprising processing the extracted information for other applications.

20. A search method as defined in claim 18, wherein the wrapper generation uses a bottom-up approach when reading the content in the vector generated during the parsing process.

21. A method as defined in claim 20, wherein the wrapper generation further follows a similarity algorithm by comparing an entry of the vector with a previous entry of the vector.

22. A method as defined in claim 21, wherein the similarity algorithm builds a similarity matrix for comparison.

23. A method as defined in claim 18, wherein a library of wrappers is created when considering information coming from several different sources.

24. A method as defined in claim 18, wherein the structure elements represented in a wrapper are selected from a group consisting of line, column, attribute, page and hyperlilnk.

25. A method as defined in claim 18, wherein the navigation organization determining step includes defining a tree form representing navigation links of the dynamic web pages.

26. A method as defined in claim 25, wherein the navigation links are organized via a breadth-first algorithm.

27. A method as defined in claim 26, wherein the navigation links are identified based on an offset in their address.
